(19) United States
(12) Patent Application Publication
(10) Pub. No.: US 2026/0197297 A1
(43) Pub. Date: Jul. 9, 2026

(54) ZERO-TRUST ROUTING USING TAGS

(71) Applicant: Cisco Technology, Inc., San Jose, CA (US)

(72) Inventors: William Mark Townsley, San Francisco, CA (US); Mark Alan Bakke, Maple Grove, MN (US)

(21) Appl. No.: 19/012,210

(22) Filed: Jan. 7, 2025

(51) Int. Cl. H04L 9/40; H04L 45/76

(52) U.S. Cl. CPC H04L 63/0236; H04L 45/76; H04L 63/029

(57) ABSTRACT

Techniques are described that enable zero-trust routing between network elements and across cloud service providers in multi-cloud network. The techniques enable customers to create and/or use tags for network elements (e.g., VPCs, VNETs, subnets, etc.). Tags from different cloud service providers with different tag semantics and/or nomenclature may be correlated (e.g., normalized), as well as verified. The techniques may use normalized and/or verified tags in order to identify the routes between network elements. The techniques allow network elements of multi-cloud networks to be interconnected on behalf of the user, as well as allow only relevant routes to be distributed to network elements (e.g., the routes between network elements that are interconnected), thus improving network and customer efficiencies.

### TECHNICAL FIELD

The present invention relates generally to cloud networking and more specifically to providing zero-trust routing across cloud service providers.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service provider (ISP) Networks that operate WANs to provide connectivity to individual users or enterprises, software-defined networks (SDNs), wireless networks, core networks, cloud networks, and so forth.

An example network is a public cloud service provider (CSP). For instance, a customer (e.g., a tenant, such as a company or an enterprise) environment can include a single CSP or multiple CPSs, such as AWS, Azure, Oracle, etc. The customer may use multiple CPS for a variety of reasons (e.g., specific features, mergers and acquisitions, dual-vendor policies, etc.). When using the CSPs, the customer may also still operate their private clouds and branches.

As an example, a customer may have workloads running in a single CSP (e.g., such as AWS). Additionally, the customer may have hundreds or even thousands of accounts or subscriptions associated with each of these workloads. For instance, a customer (e.g., such as a company) can have various teams (e.g., application teams, marketing teams, etc.). Each team can have multiple accounts within the CSP. Where the customer runs or has hundreds of teams, there can be thousands of accounts running in the single CSP, resulting in the customer needing infrastructure and IT support to run and maintain all of the accounts. Further, when the accounts of a customer are expanded across multiple cloud systems, various additional complexities and limitations are introduced that may differ between each cloud system. As an example, each CSP has its own way of tagging network elements (e.g., cloud objects). Tags can be placed on a variety of aspects such as general resources, a VPC, an instance, a subnet, etc. However, tags are not distributed across clouds, so tracking and mapping between clouds is difficult.

Further, traditional techniques also typically use a “security-first” architecture, where large amounts of routes are distributed all network elements, despite each network element only using a small portion of those routes. Subsequently, all traffic associated with the network element is ran through a firewall. This may cause a customer to send unnecessary traffic, as well create security risks.

### BRIEF DESCRIPTION OF THE DRAWINGS

The detailed description is set forth below with reference to the accompanying figures. The use of the same reference numbers in different figures indicates similar or identical items. The systems depicted in the accompanying figures are not to scale and components within the figures may be depicted not to scale with each other.

FIG. 1 illustrates an environment in which a system provides zero-trust routing using tags in a multi-cloud mesh for multi-cloud connectivity between CSPs.

FIG. 2 illustrates an environment in which a system provides an example multi-cloud mesh that provides a simplified mechanism for managing multi-cloud connectivity between CSPs.

FIG. 3 illustrates a system-architecture diagram of an environment in which a system illustrates exemplary traffic pathways enabled by the system described in FIG. 2 herein.

FIG. 4 illustrates an example embodiment in which normalized and verified tags may be used in zero trust routing between CSPs and via a multi-cloud mesh.

FIG. 5 illustrates a component diagram of an example network management system, as described in FIGS. 1-4.

FIG. 6 illustrates a flow diagram of an example system for zero-trust routing using tags in a multi-cloud mesh for multi-cloud connectivity between CSPs.

FIG. 7 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of cloud networking and more specifically to providing zero-trust routing across cloud service providers. For instance, the techniques described herein may relate to providing zero-trust routing in multi-cloud networks.

A method to perform the techniques described herein may include receiving input associated with a first tag of a first network element in the MCN, the first network element being associated with a cloud account of the MCN. The method may include determining, based on the first tag, a tag mapping between the first tag and one of a tunnel or classless interdomain routing (CIDR) group. The method may include determining, based on the tag mapping, one or more routes associated with the first network element that enable traffic flow to a second network element via the MCN. The method may also include determining, based on the tag mapping, a virtual point of presence (vPoP) associated with the first network element, and sending the one or more routes to the vPoP.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

As noted above, the use of multiple CSPs introduces various complexities for customers. Some complexities may relate to managing a customer network over multiple cloud networks. One such complexity relates to connecting different workloads and CSPs. As each cloud system has different components, connecting between cloud system(s) and the customer's private clouds and branches is difficult. For instance, a customer may want to deploy an application in two separate CSPs (e.g., such as AWS and Azure). However, how the two CSPs are structured, perform tagging, name components, etc. can be very different. This is not only highly complex but requires specialty knowledge in networking for both CSPs to enable network elements from one CSP to connect to network elements from another CSP, resulting in a need to hire staff that specialize in each CSP. Accordingly, managing the customer network can be resource intensive, complex, and costly for the customer to track and maintain.

Another complexity arises when a portion of the customer accounts are received via an acquisition or when an application team starts up from scratch. In these instances, subnet address ranges (e.g., NATs) of the accounts can overlap or have other issues that need to be addressed before the accounts can access or connect to services within the customer's network. This results in a company requiring additional specialized teams to manually correct the overlap, as well as identify and establish new connections between the customer accounts, applications, and CSPs. This is not only time-consuming and complex to sort out, but results in various accounts lacking connections to company resources and services.

Additionally, complexities can relate to inconsistencies between the different CSPs. For instance, each CSP has differences in what elements a customer can tag, what groups (or users) a customer can tag, what traffic a customer can tag, how to name the tags, how the tags are tracked across the CSP, etc. As an example, tags can be placed on a variety of network elements within a CSP, such as general resources, a VPC, an instance, a subnet, etc. The CSPs may each have a different way to tag instances or VPCs, but not all CSPs have a way to tag a subnet. Additionally, or alternatively, users may be able to add or change tag values, which may result in the user gaining access to network(s) they should not have access to. That is, existing techniques may enable users to tamper with tag values and gain access to information and networks they should not be able to access, such as by replaying a previous tag value.

Further, for each CSP, a customer can decide which of the customer networks to connect in different ways. As an example, the customer may use a user interface to indicate they want to connect VPC1 to VNET2. However, where there is a large amount of VPCs/VNETs, such as in a customer network described above, this is difficult to track, especially where the VPCs or VNETs are dynamic (e.g., VPCs generated with terraform) and may come into and out of existence every day, every hour, etc. Traditional techniques also typically use a “security-first” architecture, where large amounts of routes are distributed all network elements, despite each network element only using a small portion of those routes. Subsequently, all traffic associated with the network element is ran through a firewall. This may cause a customer to send unnecessary traffic, as well create security risks.

Accordingly, there is a need to implement zero-trust routing in multi-cloud networks, where routes are selectively distributed to network elements, CSPs, etc.

This disclosure describes techniques for providing zero-trust routing across cloud service providers. The techniques may include receiving input associated with a first tag of a first network element in the MCN, the first network element being associated with a cloud account of the MCN. The techniques may include determining, based on the first tag, a tag mapping between the first tag and one of a tunnel or classless interdomain routing (CIDR) group. The techniques may include determining, based on the tag mapping, one or more routes associated with the first network element that enable traffic flow to a second network element via the MCN. The techniques may also include determining, based on the tag mapping, a virtual point of presence (vPoP) associated with the first network element, and sending the one or more routes to the vPoP.

In some examples, the system provides the ability to have a single network management system (NMS) and a method of operation across the CSPs in a multi-cloud network (MCN), so that the customer can run workloads in their cloud of choice for various reasons (e.g., cost, capabilities, mergers/acquisitions, etc.). In some examples, the system may operate gateways in all of the availability zones of all of the CSPs, such that the system may provide MCN management as a service. For instance, the system may correspond to the NMS that includes a dashboard (e.g., such as a Meraki dashboard) and/or is implemented as an application (e.g., such as a SaaS app) that interfaces with a user device of the customer. In some examples, the system may utilize a gateway of a service provider (e.g., such as a Cisco native gateway) instead of a gateway associated with the CSP. The system may be configured to set up encrypted tunnels between all the different gateways in order to route the traffic over the internet and between CSPs.

In some examples, the system includes virtual points of presence (vPoPs). In some examples, the vPoPs comprise cloud native head end (CNHE) vPoPs and may represent an end point that the customer talks to and/or connects to. It is understood that while vPoPs may comprise CNHE vPoPs, other types of containers may be used. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts.

In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. In some examples, the vPoPs may be configured to connect the tenancies (e.g., all of Tenant A together, all of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may comprise a dashboard. In some examples, the dashboard may comprise one or more application(s) and/or API(s) that are provided by a service provider of the multi-cloud mesh (e.g., such as Cisco) to enable a customer to interface with the NMS and generate tags for various network elements. In some examples, the dashboard may enable the user to provide input to create, edit, and/or delete tag(s). In some examples, the dashboard enables the customer to tag network elements across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the network elements that are tagged as “blue” may then be discovered by the NMS and interconnected with each other, whether vPoP is connected via AWS or Azure, and/or whether the vPoP is connected to an on-premises data center (e.g., such as via a catalyst switch or a Meraki switch).

In some examples, the system may comprise a tag component. In some examples, the tag component may be configured to generate and manage tags. For instance, the tag component may be incorporated as part of the NMS, included in the dashboard, and/or included as part of an application on a user device of a customer (e.g., outside of the multi-cloud mesh). For instance, the tag component may receive input from the dashboard. The tag component may be configured to use the input to create a tag associated with a network element. For instance, the customer may provide input that includes values for one or more fields (e.g., tag name, tag value, time stamp, object ID, nonce value, etc.) of a tag. The network elements (e.g., cloud object(s)) may include VPCs, VNETs, subnet(s), instances, network interfaces, or any other object.

In some examples, the NMS may store and track tags associated with the multi-cloud mesh and/or network elements. For instance, the NMS may store mappings between various tags, CSPs, network elements, identifier(s), etc. in a database of the multi-cloud mesh and/or in memory of the NMS. The NMS may update the mappings based on changes made to tags. As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

Additionally, or alternatively, the system may be configured to normalize, or correlate, different nomenclature (e.g., different tag values, notations, etc.) used in the tagging of network elements of CSPs and/or on-premises data centers. This way, mappings associated with tags may include an indication of the normalized tags (e.g., an indication of corresponding tags between different network elements of CSPs and/or on-premises data centers). In some instances, the NMS may use, or work in combination with, the tag component to normalize different tags. Additionally, or alternatively, the tag component may be configured to receive input to create a signed tag associated with a network element, which may include one or more values (e.g., such as tag name, identifier, VPNID, nonce, etc.) in a signature for the signed tag. The tag component may also determine, when a change to a tag value is made (e.g., by a user and via the dashboard), determine whether the change is valid and authorized (e.g., whether the user is authorized to access the new network associated with the to-be-changed tag based on network policies and/or security policies). In some examples, the tag component may be configured to encrypt the tag signature using a private key, where the NMS or a validation system stores a corresponding public key used to decrypt the signature.

Once a tag is normalized and/or validated, the system may be configured to distribute tag mappings (e.g., indicating the normalized tags and/or validated tags) to vPoP(s). For instance, the system may store mappings between the tags of incoming tunnel(s) and/or classless inter domain routing groups (CIDR(s)) to equivalent VPNID, Security Group Tag values (SGTs,) etc. In some examples, the CIDR to tag mappings may comprise CIDR to SGT mappings. For instance, a CIDR to SGT mapping may refer to the process of associating a specific network IP address range (defined using CIDR notation) with a SGT value, which may allow network traffic originating from that IP range (e.g., particular subnet or range of IP addresses) to be identified and treated as belonging to a particular security group of the multi-cloud mesh. A tunnel to tag mapping may refer to one or more tags assigned to traffic traversing a particular tunnel interface and may enable granular policy enforcement based on the tunnel connection, rather than just the source or destination IP addresses.

Additionally, or alternatively, the system may be configured to establish connections between network elements based on tag mappings, such as tag mappings including normalized and/or verified tags. The NMS may be configured to identify routes between network elements, update routes based on network changes (e.g., a network gets added or removed), etc. Unlike existing techniques, the NMS may be configured to distribute routes to the appropriate network element, CSP, etc. based on tag mappings. Based on the tag mappings, the NMS is aware of which network elements and/or CSPs are communicatively coupled, or interconnected (e.g., which network elements and/or CSPs are allowed to exchange traffic with one another). By way of example, and not limitation, the NMS may determine, based on normalized and/or verified tags, that a network element (e.g., VPC) of a CSP (e.g., AWS) may send traffic to a network element associated with an on-premises data center (e.g., based on the tag of the VPC in AWS corresponding with a VPNID associated with the on-premises data center). Based on this determination, the NMS may be configured to send routes to the appropriate network elements and/or CSPs (e.g., routes to reach the on-premises data center are sent to the AWS VPC). However, the NMS may refrain from sending routes to network elements that are not communicatively coupled (e.g., a VNET associated with Azure, at which a customer has no network elements and/or network elements that are communicatively coupled to the on-premises data center via normalized tags). The NMS may also be configured to send and/or refrain from sending routes to network elements, CSPs, and/or the like based on particular regions. For example, the NMS may be configured to refrain from sending a particular route to a network element of a particular region upon a determination that a customer has no network elements and/or network elements that are communicatively coupled in that region.

As described above, tag mappings of normalized and/or validated tags, which may be sent to relevant vPoP(s), may include mappings between the tags of incoming tunnel(s) and/or CIDR(s) to equivalent tags. The NMS may be configured to determine that a tagged network element (e.g., VPC) correlates to a specific network IP address range (defined using CIDR notation), such as via tag normalization. For example, this correlation may allow traffic originating from the VPC of one CSP to be sent to a network element associated with a CIDR block of 10.1.6.0/24. As such, routing information for reaching the network element associated with 10.1.6.0/24 CIDR block may be propagated to the VPC. Additionally, or alternatively, the tagged VPC may not correlate to a network element associated with a CIDR block of 10.1.8.0/24. Accordingly, routing information for reaching the network element associated with the 10.1.8.0/24 CIDR block may not be propagated to the VPC. This way, the VPC may not send traffic to the 10.1.8.0/24 network element in the first place, as opposed to sending traffic to the 10.1.8.0/24 network element, and being unable to reach the 10.1.8.0/24 network element due to a firewall.

The system may enable routes to be distributed as a connectivity first architecture, where network elements only receive routes to other network elements that they are communicatively coupled to (e.g., have corresponding, or normalized, tags and/or validated tags), as opposed to sending all routes to all network elements. By using normalized tags and/or verified tags, the system may enable users to maintain a multi-cloud network, including network elements associated with different CSPs or on-premises data centers. Additionally, by distributing routes to network elements based on the corresponding tags, the system may enable security efficiencies, as the traffic sent to a network element from an unauthorized source may not leave a network, use its associated tunnel, etc. Further, due to the selective distribution of routes, there may be improved scalability of the multi-cloud mesh and enabling integration in environments where network elements are created and destroyed frequently (e.g., such as terraformed environments).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

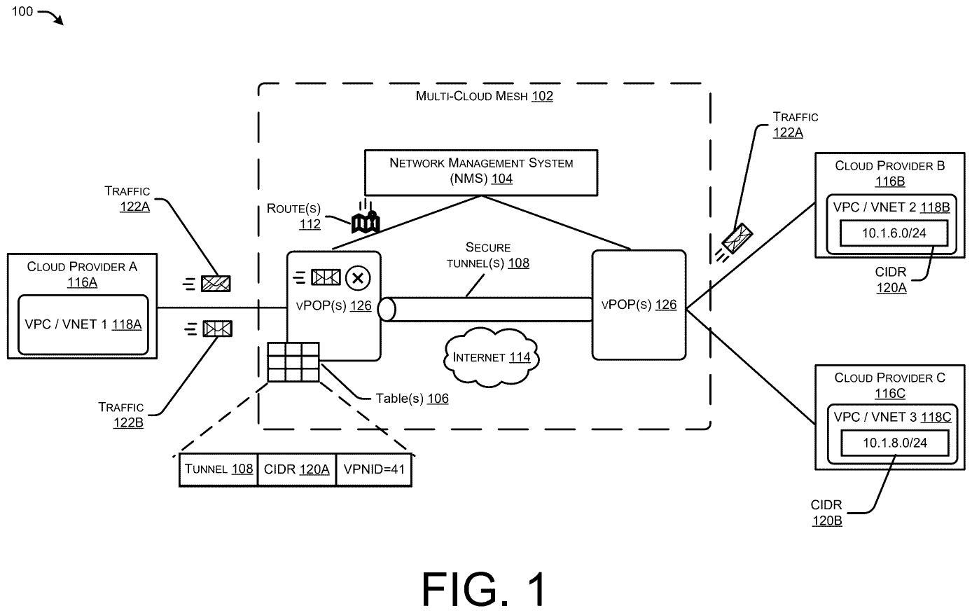

FIG. 1 illustrates an environment in which a system provides zero-trust routing using tags in a multi-cloud mesh for multi-cloud connectivity between CSPs. While the system 100 shows an example multi-cloud mesh, it is understood that any of the components of the system may be implemented on any device, network, and/or any cloud-based service provider.

In some examples, the system 100 may include multi-cloud mesh 102. As used herein, multi-cloud mesh 102 may be referenced as the “MCN” and vice versa. As described in more detail below, the multi-cloud mesh 102 may include one or more networks implemented by any viable communication technology, such as wired and/or wireless modalities and/or technologies. The multi-cloud mesh 102 may include devices, virtual resources, or other nodes that relay packets from one network segment to another by nodes in the computer network.

The system 100 may comprise cloud provider(s) (e.g., cloud provider A 116A, cloud provider B 116B, cloud provider C 116C, which may correspond to various CSPs. For instance, cloud provider A 116A may represent AWS, cloud provider B 116B may represent Azure, and cloud provider C 116C may represent GPC. It is understood that while FIG. 1 includes cloud providers 116, the system 100 may similarly include, and/or be applied to, on-premises network elements (e.g., on-premises SD-WAN). Each cloud provider 116 may provide services to a tenant(s), which may correspond to a different customer (e.g., such as an enterprise, organization, private entity, etc.). Additionally, or alternatively, a tenant may use multiple cloud providers 116. For instance, the services may include virtual private clouds, virtual networks (VPC/VNET 1 118A, VPC/VNET 3 118C), and/or the like. As illustrated, the services provided by each cloud provider is located outside of the multi-cloud mesh 102.

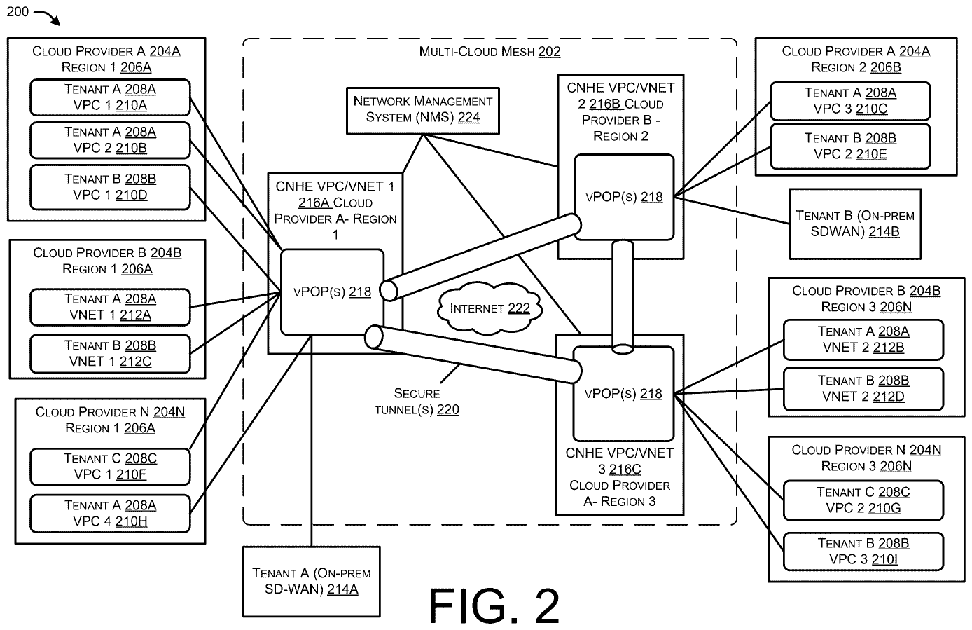

The multi-cloud mesh 102 may comprise network management system (NMS) 104. As described in more detail below with respect to FIG. 2, the NMS 104 may correspond to a system that has complete visibility into the fabric of a given network. In some examples, the NMS 104 may be configured to generate cloud infrastructure templates (e.g., AWS cloud formation templates) and vPoP(s) 126. While not illustrated, the NMS 104 may be connected to one or more CNHE VPC/VNET(s) that comprise vPoP(s) 126, such that the NMS 104 can monitor, manage, and update each vPoP. The CNHE VPC/VNET(s) may correspond to a VPC or a VNET that is owned and/or managed by a service provider of the NMS (e.g., such as Cisco). It is understood that while vPoPs 126 may comprise CNHE VPC/VNET(s), other types of containers may be used.

As illustrated in FIG. 1, the vPoP(s) 126 is configured to connect each VPC/VNET 118 running in cloud providers 116. Additionally, the vPoP(s) 126 may be configured to connect to an on-premises SD-WAN using various protocols. configured to connect to each VPC and VNET running in cloud provider A 116A, cloud provider B 116B, and cloud provider N 104N. Additionally, the vPoP(s) 126 may be configured to connect to an on-premises SD-WAN using various protocols. The vPoP(s) 126 are configured to connect to each VPC and VNET running in each cloud provider.

As illustrated, the vPoP(s) 126 are connected using secure tunnel(s) 108, which may represent encrypted data tunnels or tunnels created using any secure tunneling protocol. In some examples, the secure tunnel(s) 108 may be associated with a connection determined by a tenant, such that traffic from different tenants may be routed according to different protocols. Further, as illustrated, the vPoP(s) may be configured to communicate over the internet 114 or any other suitable network connection (e.g., core(s), 100GB core, etc.).

In some examples, the vPoP(s) 126 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco). In some examples, the vPoP(s) 126 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

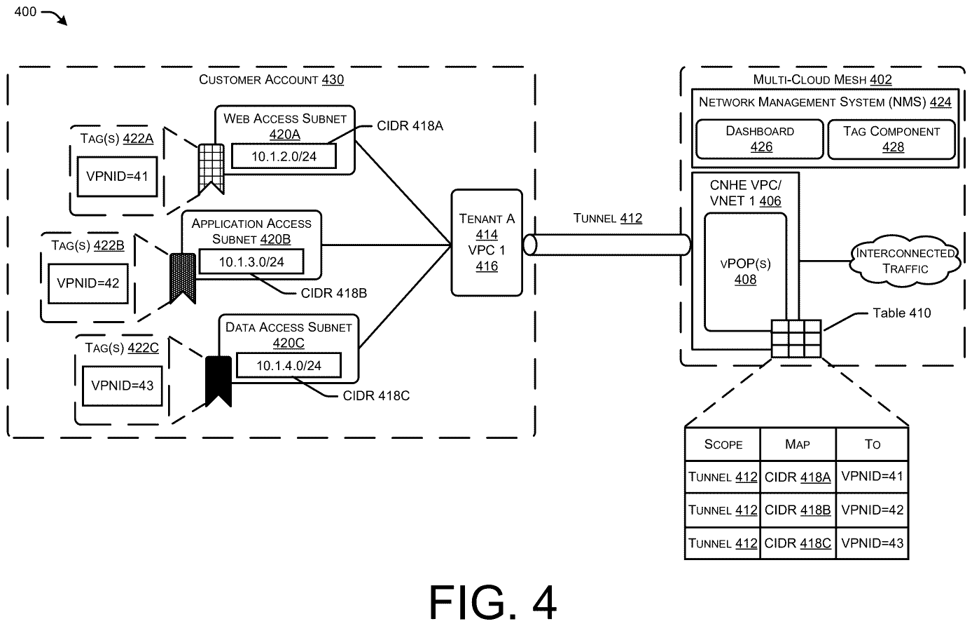

As described in more detail below with respect to FIG. 4, cloud providers 116 may be associated with tags. Tags may include a tag name, tag value, object ID, nonce value, etc.). For example, each of the VPC/NETs 118 may be tagged using different nomenclatures (e.g., different semantics, values, notations, etc.). The NMS 104 may be configured to connect, or hook, VPC/NETs 118. In some instances, and as described below with respect to FIG. 4, the NMS 104 may use, or work in combination with, a tag component and/or verification system which may comprise one or more pre-trained models and/or pre-trained weighted models in order to normalize tags, such that differently-tagged network elements from different CSPs may be hooked together, as well as verify tags created, altered, etc. In some examples, the artificial intelligence models are pre-trained using machine learning techniques. In some examples, the NMS 104, tag component, and/or verification system may store machine-trained data models for use during operations, such as normalizing tags. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the tag component may update the one or more machine learning models based on feedback received from the NMS 104, outputs from the machine learning models, and/or a network administrator.

As described above, the NMS 104 may be configured to connect and/or hook together the network elements, such as VPC/VNETs 118 of different cloud providers 116 based on normalized and/or verified tags. As such, the NMS 104 may establish connections between VPC/VNETs 118 based on tag mappings, such as tag mappings including normalized and/or verified tags. Tag mappings may be distributed to relevant vPoP(s) 126, which may be included in a table such as table 106. For example, as illustrated in table 106 of FIG. 1, CIDR 120A (which may be associated with an IP address of 10.1.6.0/24.0/24 in CIDR notation) may be mapped to VPNID=41, where traffic 122A that may come over the tunnel and matching the VPNID=41 may be mapped to CIDR 120A. In other words, traffic 122 coming over the tunnel(s) 108 and matching the VPNID=41 may “take on” the CIDR 120A in the multi-cloud mesh 102. These mappings may be distributed to relevant vPoPs, such as vPoP(s) 126, as the table 106. The table 106 may be stored in memory of the vPoP(s) 126 and/or network elements that the vPoP(s) 126 are running in.

Additionally, or alternatively, the NMS 104 may be configured to identify routes between network elements, such as between VPC/VNETs 118, cloud providers 116, etc. The NMS 104 may also update route(s) 112 based on network changes (e.g., a network gets added or removed), etc. Unlike existing techniques, the NMS 104 may be configured to distribute route(s) 112 to the appropriate network element, CSP, etc. based on tag mappings (e.g., mappings in table 106). Based on the tag mappings, the NMS is aware of which network elements and/or CSPs are communicatively coupled, or connected (e.g., which network elements and/or CSPs are allowed to exchange traffic with one another). As described above, as part of normalizing tags, NMS 104 may determine that the tags of VPC/VNET 1 118A may be mapped to the tags of VPC/VNET 2 118B (e.g., VPNID=41 to CIDR 120A). These tags may also be verified using the techniques described herein. Based on this determination, the NMS 104 may be configured to send route(s) 112 to the appropriate VPC/VNETs 118 and/or cloud providers 116. In some instances, the NMS 104 may also be configured to refrain from sending certain routes to VPC/VNETs 118 and/or cloud providers 116.

For example, as described above, tag mappings of normalized and/or validated tags, which may be sent to relevant vPoP(s) 126, may include mappings between the tags of incoming tunnel(s) and/or CIDR(s) to equivalent tags, such as those illustrated in table 106. It is understood that the NMS 104 may similarly use non-normalized and/or non-verified tags, and/or other techniques for connecting network elements of different CSPs, in order to determine the distribution of route(s) 112. Based on the tag mappings between VPC/VNET 1 118A and VPC/VNET 2 118B, the NMS 104 may send route(s) 112 (e.g., BGP routes) for traffic 122A from VPC/VNET 1 118A to reach VPC/VNET 2 118B. For example, the NMS 104 may send to VPC/VNET 1 118A and/or cloud provider A 116A the BGP routes across the secure tunnel(s) 108 for reaching CIDR 120A (e.g., 10.1.6.0/24). While not illustrated, the NMS 104 may be configured to send multiple routes to VPC/VNETs 118 and/or cloud providers 116 for reaching other network elements. Additionally, or alternatively, tag mappings may indicate that VPC/VNET 1 118A has no correlation to VPC/VNET 3 118C (e.g., tag mappings not included in table(s) 106). Based on the lack of tag mappings between VPC / VNET 1 118A and VPC/VNET 3 118C, the NMS 104 may refrain from sending routes for traffic 122B from VPC/VNET 1 118A to reach VPC/VNET 3 118C. For example, the NMS 104 may refrain from sending to VPC/VNET 1 118A and/or cloud provider A 116A the BGP routes across secure tunnel(s) 108 for reaching CIDR 120B (e.g., 10.1.8.0/24). This way, VPC/VNET 1 118A may not send traffic 122B to the IP address of 10.1.8.0/24 over secure tunnel(s) 108 in the first place, as opposed to being unable to reach the 10.1.8.0/24 IP address due to a firewall.

FIG. 2 illustrates a system-architecture diagram of an environment in which a system 200 provides an example multi-cloud mesh that provides a simplified mechanism for managing multi-cloud connectivity between CSPs. While the system 200 shows an example multi-cloud mesh, it is understood that any of the components of the system may be implemented on any device, network, and/or any cloud-based service provider. Moreover, it is understood that any of the components illustrated in FIGS. 1 and 3-6 may be implemented and/or incorporated in the multi-cloud mesh. Additionally, or alternatively, system 200 may correspond to system 100 of FIG. 1. For example, one or more components of the system 200 may correspond to one or more components of the system 100 of FIG. 1 (e.g., multi-cloud mesh 202 corresponds to multi-cloud mesh 102, vPoP(s) 218 correspond to vPoP(s) 126, cloud providers A-N 204A-N correspond to cloud providers A-C 116A-C, etc.).

In some examples, the system 200 may include multi-cloud mesh 202. The multi-cloud mesh 202 may include one or more networks implemented by any viable communication technology, such as wired and/or wireless modalities and/or technologies. The multi-cloud mesh 202 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, SD-WANs, SDNs—and/or any combination, permutation, and/or aggregation thereof. The multi-cloud mesh 202 may include devices, virtual resources, or other nodes that relay packets from one network segment to another by nodes in the computer network. The multi-cloud mesh 202 may include multiple devices that utilize the network layer (and/or session layer, transport layer, etc.) in the OSI model for packet forwarding, and/or other layers. In some examples, the multi-cloud mesh 202 correspond to an SD-WAN overlay.

The system 200 may comprise cloud provider(s) (e.g., cloud provider A 204A, cloud provider B 204B, cloud provider N 204N), which may correspond to various CSPs. For instance, cloud provider A 204A may represent AWS, cloud provider B 204B may represent Azure, and cloud provider N 204N may represent GPC.

Each cloud provider may have one or more site(s) associated with a particular region (e.g., region 1 206A, region 2 206B, region 3 206N, etc.). For instance, region 1 206A may represent a western portion of a particular geographic location (e.g., country, state, city, or any other suitable geographic location), region 2 may represent a central portion of the geographic location, and region 3 206N may represent an eastern portion of the geographic location.

The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the packet-forwarding networks may not be located in explicitly defined data centers but may be located in other locations or buildings. In some examples, the site(s) comprise network device(s), which may correspond to any computing device, routers, switches, computers, or any other type of network device. Edge device(s) may comprise routers, switches, access points, stations, radios, and/or any other network device.

Each cloud provider may be multi-tenanted. For instance, cloud provider A 204A in region 1 206A may provide services to tenant A 208A and tenant B 208B. Each tenant may correspond to a different customer (e.g., such as an enterprise, organization, private entity, etc.). As illustrated, tenant A 208A may utilize services provided by cloud provider A 204A, cloud provider B 204B, and cloud provider N 204N. For instance, the services may include virtual private clouds (VPC(s) 210) or virtual networks (VNET(s) 212) that each respective tenant pays the cloud service provider for. As illustrated, the services provided by each cloud provider to each respective tenant is located outside of the multi-cloud mesh 202.

As illustrated in FIG. 2, cloud provider A 204A may run various VPCs for each tenant in each region. For instance, for tenant A 208A, cloud provider A 204A may run VPC 1 210A and VPC 2 210B in region 1 206A and VPC 3 210C in region 2 206B. For tenant B, cloud provider A 204A may also run VPC 1 210D in region 1 206A and VPC 2 210E in region 2. Similarly, cloud provider B 204B may be configured to provide VNET services to tenants. As illustrated for tenant A 208A, cloud provider B 204B may run VNET 1 212A in region 1 206A and VNET 2 212B in region 3 206N. For tenant B, cloud provider B 204B may run VNET 1 212C in region 1 206A and VNET 2 212D in region 3 206N. Cloud provider N may also be configured to provide VPC services. For instance, for tenant C 208C, cloud provider N 204N may provide VPC 1 210F in region 1 206A and VPC 2 210G in region 3. For tenant A, cloud provider N 204N may provide VPC 4 210H in region 1. For tenant B, cloud provider N may provide VPC 3 210I in region 3.

Additionally, each tenant may have one or more physical location(s). For instance, tenant A 208A may have an on-premises SD-WAN 214A. In some examples, the tenant A on-premises SD-WAN 214A may comprise a site or physical data center of tenant A. In some examples, the tenant A on-premises SD-WAN 214A may utilize features or protocols to connect to the multi-cloud mesh 202, such as Meraki and/or AutoVPN. Tenant B 208B may have an on-premises SD-WAN 214B. In some examples, the tenant B on-premises SD-WAN 214B may comprise a site or physical data center of tenant B and may be located in region 2. In some examples, the tenant B on-premises SD-WAN 214B may utilize features or protocols to connect to the multi-cloud mesh 202, such as Cisco's Catalyst IPsec and/or ISR.

The multi-cloud mesh 202 may comprise network management system (NMS) 224. The NMS 224 may correspond to a system that has complete visibility into the fabric of a given network. In some examples, the NMS 224 may comprise one or more controllers, one or more processors, memory, one or more APIs, one or more applications, one or more components, etc. In some examples, and as described in greater detail below, the NMS 224 may be configured to generate cloud infrastructure templates (e.g., AWS cloud formation templates) and vPoP(s) 218. As illustrated in FIG. 1, the NMS 224 may be connected to one or more CNHE VPC/VNET(s) 216 that comprise vPoP(s) 218, such that the NMS 224 can monitor, manage, and update each vPoP. It is understood that while vPoPs 218 may comprise CNHE VPC/VNET(s) 216, other types of containers may be used.

The CNHE VPC/VNET(s) 216 may correspond to a VPC or a VNET that is owned and/or managed by a service provider of the NMS (e.g., such as Cisco). As illustrated in FIG. 1, each CNHE VPC/VNET may be deployed within a particular cloud service provider and/or region. For instance, CNHE VPC/VNET 1 216A may run in cloud provider A region 1, CNHE VPC/VNET 2 216B may run in cloud provider B region 2, and CNHE VPC/VNET 3 216C may run in cloud provider A region 3. Accordingly, where cloud provider A represents AWS, CNHE VPC/VNET 1 216A and CNHE VPC/VNET 3 216C may represent instances of VPCs running in AWS. Where cloud provider B represents Azure, CNHE VPC/VNET 2 216B may represent instances of a VNET running in Azure. While the CNHE VPC/VNET(s) are illustrated as being run in different cloud providers, it is understood that a single CSP may be used or additional CSPs may be used.

As illustrated in FIG. 1, the vPoP(s) 218 in CNHE VPC/VNET 1 216A is configured to connect to each VPC and VNET running in cloud provider A 204A, cloud provider B 204B, and cloud provider N 204N in region 1 206A. Additionally, the vPoP(s) 218 in CNHE VPC/VNET 1 216A may be configured to connect to Tenant A on-premises SD-WAN 214A using various protocols. The vPoP(s) 218 in CNHE VPC/VNET 2 216B is configured to connect to each VPC and VNET running in each cloud provider in region 2 206B. Additionally, the vPoP(s) 218 in CNHE VPC/VNET 2 216B may be configured to connect to Tenant B on-premises SD-WAN 214B using various protocols. The vPoP(s) 218 in CNHE VPC/VNET 3 216C is configured to connect to each VPC and VNET running in each cloud provider in region 2 206B. Additionally, the vPoP(s) 218 in CNHE VPC/VNET 2 216B may be configured to connect to Tenant B on-premises SD-WAN 214B using various protocols.

As illustrated, the vPoP(s) 218 are connected using secure tunnel(s) 220, which may represent encrypted data tunnels or tunnels created using any secure tunneling protocol. In some examples, the secure tunnel(s) 220 may be associated with a connection determined by a tenant, such that traffic from different tenants may be routed according to different protocols. Further, as illustrated, the vPoP(s) may be configured to communicate over the internet 222 or any other suitable network connection (e.g., core(s), 100GB core, etc.).

In some examples, the vPoP(s) 218 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system 200 with improved latency characteristics and enabling the system 200 to leverage specific functionalities of each CSP. Thus, by utilizing CNHE vPoPs, the system 200 may provide lightweight vPoPs that can be located anywhere (e.g., such as within a cloud) and can be set up in a new region within minutes.

Accordingly, the vPoPs deployed by the system 200 are outside of the CSP regions that are owned by the customer (e.g., and instead are deployed in VPCs/VNETs of the service provider), such that the system 200 is not deploying code, virtual machines, instances, etc. of the vPoPs to the customer network(s), thereby enabling the customer to implement the system 200 without having to allocate additional network resources (e.g., CPU, memory, etc.) of network devices, or increasing costs to the customer. Moreover, by deploying the vPoPs within the multi-cloud mesh 202, the NMS 224 is configured to handle software upgrades, security tickets, etc. on behalf of the customer, such that the customer does not need to see or handle updates or security tickets for thousands of accounts.

In some examples, the vPoP(s) 218 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the vPoP(s) 218 and/or NMS 224 may be configured to keep one or more of data traffic, routes, statistics, etc. of different tenants separate from each other. In some examples, the vPoP(s) 218 may be configured to connect the tenancies (e.g., all of Tenant A together, All of Tenant B together, etc.). Each vPoP may be configured to transmit data to each other over the internet 222, or other cores (e.g., such as a 100 GB core). Accordingly, the system may be configured to provide a per-customer topology between the vPoPs that is automated, provides flexibility in the types of tunnels, improved throughput, flexibility in the number of tunnels used (e.g., single or multiple tunnels), and/or provides balancing across the tunnels when needed (e.g., such as to get around administration limitations).

Thus, the multi-cloud mesh 202 may be configured to provide a connectivity first architecture (versus a security first architecture that runs everything through a firewall). As used herein, “connectivity first” means some of the security features of the multi-cloud mesh 202 is based on the connections selected by each tenant. For example, tenant A 208A can choose to connect VPC 1 210A and VPC 3 210C, but nothing else. In this example, the NMS 224 may distribute the routes for connecting VPC 1 210A and VPC 3 210C and may ensure that traffic sent/received by VPC 1 210A is to/from VPC 3 210C and vice versa. In some examples, the NMS 224 may distribute stateless firewalls to edge device(s) within the multi-cloud mesh 202, such that the techniques may not need to provide a central service all the time.

In this way, the system may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

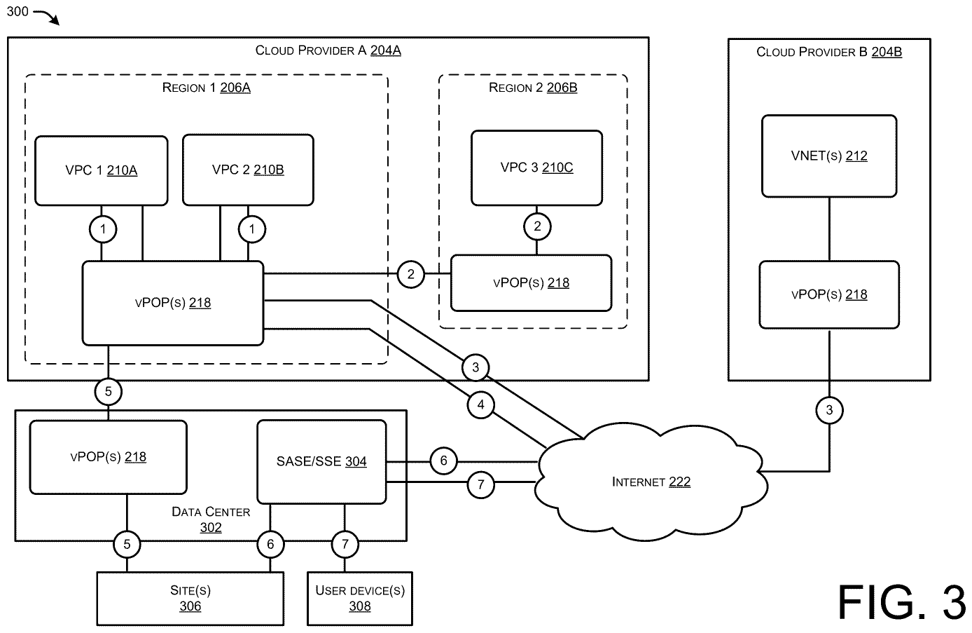

FIG. 3 illustrates a system-architecture diagram of an environment in which system 200 illustrates exemplary traffic pathways enabled by the system described in FIG. 1 herein. As illustrated, the system 200 may include cloud provider A, 204A cloud provider B 204B, region 1 206A, region 2 206B, VPC 1 210A, VPC 2 210B, VPC 3 210C, VNET(s) 212, vPoP(s) 218, and internet 222. Additionally, the system 300 may include data center 302, SASE/SSE 304, site(s) 306, and user device(s) 308.

Data center 302 may represent a physical location, such as a co-located data center, a head end, and/or any other data center associated with a service provider (e.g., such as cisco). In some examples, the data center 302 may be associated with a tenant, such as tenant A 208A. Site(s) 306 may correspond to a branch or datacenter, such as an on-premises location of tenant A 208A. User device(s) 308 may correspond to any computing device (e.g., computer, tablet, cell phone, laptop, etc.) configured to enable a network administrator or other user of tenant A 208A to connect to the multi-cloud mesh. SASE/SSE 304 may represent services (e.g., secure access services edge (SASE) and security service edge (SSE) associated with security features associated with accessing a cloud (e.g., such as SD-WAN or other connections). Further, as noted above, the vPoP(s) may be integrated and/or included as part of CNHE(s) that are configured to run multi-tenanted in a cloud as a service that is managed by a service provider (e.g., Cisco).

As illustrated, the techniques described herein enable various traffic pathways. For instance, “1” represents VPC to VPC traffic, where the vPoP(s) 218 are configured to monitor the traffic and provide simplicity, observability, security, and improved connectivity between a single region of a cloud provider. At “2”, traffic is sent between regions of a single cloud provider. In this example, the vPoP(s) 218 may be configured to add cross region encryption to the traffic, thereby providing lightweight security. “3”, illustrates that traffic may be sent cloud to cloud. In this example, the system may add cross cloud connectivity between vPoP(s). “4” illustrates that traffic may be sent cloud to internet. In this example, the vPoP(s) 218 may be configured to provide ingress and/or egress security, and may be configured to perform NAT. In some examples, pathways 1-4 are performed within the multi-cloud mesh 202, such that they do not apply to the hardware of the edge device(s).

“5” illustrates site to cloud pathway. In particular, pathway 5 illustrates the ability to utilize the vPoP(s) to enable a site 306 to automatically hook into a service provider's SD-WAN (e.g., such as Cisco SD-WAN). For instance, the site 306 may utilize Meraki AutoVPN, catalyst SD-WAN, or any other suitable protocol to enable site-to-cloud connectivity. “6” illustrates traffic sent from the site(s) 306 through the cloud. In this example, the site may utilize a SASE to connect to the multi-cloud mesh 202. “7” illustrates a device through cloud traffic pathway. In this example, the user device(s) 308 may utilize SSE 304 to connect to the multi-cloud mesh 202. Accordingly, the multi-cloud mesh 202 may utilize vPoP(s) 218 to enable various types of connections and traffic flows for tenants, thereby simplifying connectivity between different CSPs and enabling tenants to run their workloads in their cloud of choice with minimal setup or management of the connections. Thus, the vPoP(s) and the multi-cloud mesh 202 may ensure that IP addresses between VPCs/VNETs do not overlap or conflict and may provide lightweight security features. Thus, the techniques may provide a per-customer topology between vPoP(s) that is automated and provides flexibility in the type(s) and number of tunnels utilized, and may provide balancing across tunnels on behalf of the tenant.

FIG. 4 illustrates an example embodiment 400 in which normalized and verified tags may be used in zero trust routing between CSPs and via a multi-cloud mesh. It is understood that multi-cloud mesh 402 may correspond to multi-cloud mesh 102 and/or 202, NMS 424 may correspond to NMS 104 and/or 224, CNHE VPC/VNET 406 may correspond to CNHE VPC/VNET 118A, 118B, 118 216A, 216B, 216C, vPoPs 408 may correspond to vPoP(s) 126 and/or 218, etc. In some instances, one or more components of the NMS 424 may run on and/or include one or more computing devices in, or associated with, the multi-cloud mesh 402 (e.g., a single device or system of devices, user device(s), etc.). Generally, the NMS 424 may include a programmable controller that manages some or all of the controller activities of the multi-cloud mesh 402 and/or MCN and manages or monitors the network state using one or more centralized control models.

In some examples, the NMS 424 may include one or more of a dashboard 426 and/or a tag component 428. In some examples, the NMS 424 may include additional or fewer components.

The dashboard 426 may comprise one or more application(s) and/or API(s) that are provided by a service provider of the multi-cloud mesh (e.g., such as Cisco) to enable a customer to interface with the network management system and generate tags for various network elements (e.g., cloud object(s)). In some examples, the dashboard may enable the user to provide input to create, edit, and/or delete tag(s). In some examples, the dashboard enables the customer to tag network elements across the multi-cloud mesh 402. The dashboard may also enable the customer to indicate whether they want the NMS 424 to connect or hook together particular traffic and/or tags. For instance, the dashboard 426 may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. The dashboard 426 may also enable the customer to hook together traffic and/or different tags associated with different CSPs, on-premises network elements, etc.

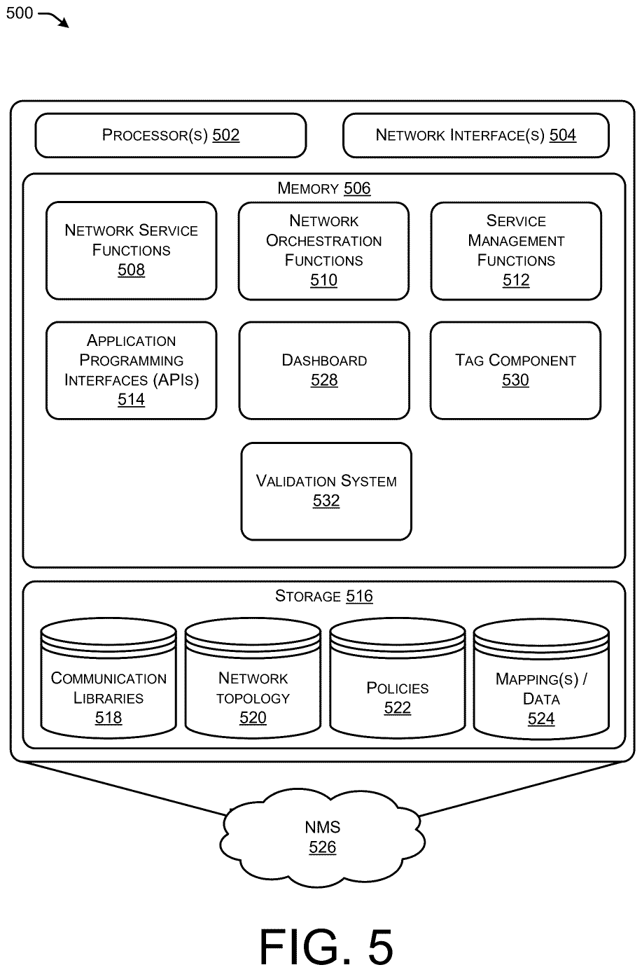

In some examples, the NMS 424 may store and track tags 422 associated with the multi-cloud mesh 402 and/or network elements. For instance, the NMS 424 may store mappings between various tags, CSPs, network elements, identifier(s), etc. in a database of the multi-cloud mesh and/or in memory of the NMS 424. For example, NMS 424 may update mappings based on changes made to tags 422A-422C of customer account 430, as well as based on normalizations associated with the tags 422A-422C. For example, as described in more detail below with respect to FIG. 5, the NMS 424 may use, or work in combination with, the tag component 428 in order to normalize, or correlate, different nomenclature (e.g., different tag values, notations, etc.) used in the tagging of network elements of CSPs and/or on-premises data centers. In normalizing the tags 422, the NMS 424 may map different tags to one another (e.g., a tag mapping). Additionally, or alternatively, tag mappings may include mappings between tags of incoming tunnel(s) and/or classless inter domain routing groups (CIDR(s)) to equivalent VPNIDs, SGTs, etc. For instance, a CIDR to VPNID mapping may refer to the process of associating a specific network IP address range (defined using CIDR notation) with a VPNID value, which may allow network traffic originating from that IP range (e.g., particular subnet or range of IP addresses) to be identified within the multi-cloud mesh 402. Tag normalization may also include correlating tags assigned to traffic traversing a particular tunnel interface, such as tunnel 412, and may enable granular policy enforcement based on the tunnel connection, rather than just the source or destination IP addresses.

While not illustrated, the NMS 424 may use, or work in combination with, a validation system, which may be configured to validate signatures of tags. In addition to normalizing tags across CSPs, on-premises data centers, etc., the tag component 428 may be configured to generate a signed tag based on the values input by the customer. In some examples, the signature may be generated by the tag component at the user device (e.g., such as by the application). In some examples, the tag component 428 may include one or more of the values (e.g., such as tag name, VPNID, nonce, etc.) in a signature for the signed tag. By including the one or more values in the signature of the tag, the tag component may ensure that the signature is unable to be copied from one network to another. In some examples, the tag component 428 may be configured to encrypt the tag signature using a private key, where the NMS 424 or a validation system stores a corresponding public key used to decrypt the signature.

A validation system may correspond to a certificate authority or other security system that stores public key(s), credential(s), certificate(s), etc. associated with application(s) or other network elements. In some examples, the validation system may store public key(s) associated with the tag(s) and/or application(s). The validation system may be configured to receive a signed tag, a cryptographical signature, and/or an encrypted signature of a tag from the tag component. The validation system may provide, to the tag component and based on the signature, a public key associated with the application. The tag component may validate that the tag is signed by the particular application and verify that the NMS 424 can trust the application.

Once a tag has been normalized and/or validated by the NMS 424 and/or tag component 428, the network management system 424 may be configured to distribute tag mappings to relevant vPoP(s) 408 within the multi-cloud mesh 402. In some instances, the NMS 424 may use, or work in combination with, tag component 428 to distribute the tag mappings (e.g., stored in table 410) to vPoP(s) 408. The table 410 may be stored in memory of the vPoP(s) 408 and/or network elements that the vPoP(s) 408 are running in (e.g., CNHE VPC/VNET 1 406). As illustrated, the table 410 may include tag mappings such as tunnel/CIDR to tag mappings. For example, a CIDR 418A of subnet 420A may be mapped to VPNID=41, where traffic that may come over the tunnel 412 and matching CIDR 418A may be mapped to VPNID=41. CIDR 418B of subnet 420B may be mapped to VPNID=42, where traffic that may come over the tunnel 412 and matching CIDR 418B may be mapped to VPNID=42. CIDR 418C of subnet 420C may be mapped to VPNID=43, where traffic that may come over the tunnel 412 and matching CIDR 418C may be mapped to VPNID=43.

Additionally, or alternatively, the NMS 424 may be configured to use tag mappings (e.g., of normalized and/or validated tags) in order to distribute routes to different network elements. For example, based on the tag mappings, the NMS 424 may be configured to identify routes between network elements, update routes based on network changes (e.g., a network gets added or removed), etc. In other words, based on the tag mappings in table 410, the NMS 424 is aware of which network elements are communicatively coupled, and in turn, where VPC 1 416 of tenant A 414 is allowed to send traffic to (e.g., the routes associated with VPC 1 416 and over tunnel 412). The NMS 424 may distribute the routes for connecting VPC 1 416 to one or more network elements, and may ensure that traffic sent by VPC 1 416 is to a network element that VPC 1 416 is allowed to send traffic to (e.g., based on the CIDR group associated with the receiving network element(s)).

FIG. 5 illustrates a component diagram 500 of an example NMS 526, as described in FIGS. 1-4. In some instances, one or more of the components of the NMS 526 may run on and/or include one or more computing devices in, or associated with, the MCN (e.g., a single device or a system of devices, such as an NMS 526, user device(s) 308, etc.). Generally, the NMS 526 may include a programmable controller that manages some or all of the controller activities of the multi-cloud mesh 102, 202, and/or 402, and/or MCN and manages or monitors the network state using one or more centralized control models.

As illustrated, the NMS 526 may include, or run on, one or more hardware processors 502 (processors), one or more devices, configured to execute one or more stored instructions. The processor(s) 502 may comprise one or more cores. Further, the NMS 526 may include or be associated with (e.g., communicatively coupled to) one or more network interfaces 504 configured to provide communications with network device(s), the edge device(s), and other devices, and/or other systems or devices in the multi-cloud mesh 102 and/or MCN and/or remote from the multi-cloud mesh 102 and/or MCN. The network interfaces 504 may include devices configured to couple to personal area networks (PANs), wired and wireless local area networks (LANs), wired and wireless wide area networks (WANs), SDCI's, and so forth. For example, the network interfaces 504 may include devices compatible with any networking protocol.

The NMS 526 may also include memory 506, such as computer-readable media, that stores various executable components (e.g., software-based components, firmware-based components, etc.). The memory 506 may generally store components to implement functionality described herein as being performed by the NMS 526. The memory 506 may store one or more network service functions 508, such as a slicing manager, a topology manager to manage a topology of the multi-cloud mesh 102, a host tracker to track what network components are hosting which programs or software, a switch manager to manage switches of the multi-cloud mesh 102, a process manager, and/or any other type of function performed by the NMS 526.

The NMS 526 may further include network orchestration functions 510 stored in memory 506 that perform various network functions, such as resource management, creating and managing network overlays, programmable APIs, provisioning or deploying applications, software, or code to hosts, and/or perform any other orchestration functions. Further, the memory 506 may store one or more service management functions 512 configured to manage the specific services of the multi-cloud mesh 102 and/or MCN (configurable), and one or more APIs 514 for communicating with devices in the multi-cloud mesh 102 and/or MCN and causing various controller functions to occur.

In some examples, the NMS 526 may include one or more of a dashboard 528, a tag component 530, and/or a validation system 532. In some examples, the NMS 526 may include additional or fewer components.

The dashboard 528 may comprise one or more application(s) and/or API(s) that are provided by a service provider of the multi-cloud mesh (e.g., such as Cisco) to enable a customer to interface with the network management system and generate tags for various network elements. In some examples, the dashboard may enable the user to provide input to create, edit, and/or delete tag(s). In some examples, the dashboard enables the customer to tag network element(s) across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the vPoPs that are tagged as “blue” may then be interconnected with each other, whether vPoP is connected via AWS or Azure, and/or whether the vPoP is connected to an on premises data center (e.g., such as via a catalyst switch or a Meraki switch).

In some examples, the NMS may store and track tags associated with the multi-cloud mesh and/or network elements. For instance, the NMS may store mappings between various tags, CSPs, network elements, identifier(s), etc. in a database of the multi-cloud mesh and/or in memory of the NMS. The NMS may update the mappings based on changes made to tag value(s). As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

The tag component 530 may be configured to generate, track, and manage tags. For instance, the tag component may be incorporated as part of the NMS, included in a dashboard, and/or included as part of an application on a user device of a customer (e.g., outside of the multi-cloud mesh). For instance, the tag component may receive input from the dashboard. The tag component may be configured to use the input to create a signed tag associated with a network element. For instance, the customer may provide input that includes values for one or more fields (e.g., tag name, tag value, object ID, nonce value, etc.) of a tag. The network element(s) may include network elements such as VPCs, VNETs, subnet(s), instances, network interfaces, or any other object. The tag component 530 may generate a signed tag based on the values input by the customer. In some examples, the signature may be generated by the tag component at the user device (e.g., such as by the application). In other examples, such as where the application is integrated as part of the NMS, the NMS may generate the signed tag via the tag component.

In some examples, the tag component 530 may include one or more of the values (e.g., such as tag name, VPNID, nonce, etc.) in a signature for the signed tag. In some examples, a name of the entity or an identifier of the entity may also be included in the signature. In some examples, the tag may include a nonce value. The nonce value may be a value added by the customer or a value generated by a service provider of the multi-cloud mesh (e.g., Cisco). The signature may comprise a cryptographical signature and/or may be hashed using any suitable hashing technique. Accordingly, by including the one or more values in the signature of the tag, the tag component may ensure that the signature is unable to be copied from one network to another. For instance, by including the nonce value, the system may ensure that even where the same hashing algorithm is run with known values of the tag being the same, the hashed value of the signed tag will still be different. Accordingly, the system may provide the ability to trust network elements across the CSPs.

In some examples, the tag component 530 may enable the user to edit one or more values of the tag. For instance, a user may update a value of one or more of the fields of the tag (e.g., such as the name, nonce value, etc.). As noted above, under existing techniques changing a value of a tag could provide access to network(s) the user should not have access to. For instance, a user may take a valid or previously used tag value and replay it, resulting in the user gaining access to networks and/or network elements they should not have access to.

Unlike existing techniques, by the tag component may, when a change to a tag value is made, determine whether the change is valid and authorized. For instance, the tag component may determine whether the change in the tag value will result in the user accessing a new network. In this example, the system may determine, based on network policies and/or security policies, whether the user is authorized to access the new network. Where the system determines that the user is not authorized to access the new network, the system may indicate that the change in the tag value is invalid. In this example, the system may ignore the new invalid tag and may continue to allow traffic from the network element using the previous valid tag. Additionally, the system may output an alert to the user via the dashboard indicating the new tag is invalid. Accordingly, the system may prevent users from other users of the MCN and/or network elements with IAM roles from changing tag values and gaining access to networks they shouldn't, thereby improving security within the MCN.

In some examples, such as where the tag component is implemented on a user device of a customer (e.g., as part of an application, etc.), the tag component may, once the tag is generated, send the tag to a network element (e.g., such as a VPC of the user running in a CSP) via an API (e.g., such as an AWS API) for storage and use. The VPC at the CSP may be associated with a customer account and may store the tag in memory and utilize the tag in connection with the network element (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new network element.

In some examples, the tag component 530 may be configured to encrypt the tag signature using a private key, where the NMS or a validation system stores a corresponding public key used to decrypt the signature. In some examples, the tag component 530 may be configured to utilize one or more machine learning and/or artificial intelligence models to generate the signed tags and/or encrypt the signed tags.

In some examples, the tag component may be configured to read tags received and/or generated at the user device. For instance, the tag component may receive, via the dashboard, application, and/or network element, an indication of a new tag created by the user. The tag component may be configured to utilize the validation system to validate the tag.

Additionally, or alternatively, the NMS 526 may use the tag component 530 in order to normalize, or correlate, different nomenclature (e.g., different tag values, notations, etc.) used in the tagging of network elements of CSPs and/or on-premises data centers. This way, mappings associated with tags may include an indication of the normalized tags (e.g., an indication of corresponding tags between different network elements of CSPs and/or on-premises data centers). The NMS 526 may be configured to store and track tags associated with the multi-cloud mesh and/or network elements. Additionally, or alternatively, the NMS may be configured to determine connectivity between different network elements of CSPs and/or on-premises data centers, propagate routes, identify access permissions, etc. This information may be usable, along with other types of information, by the NMS to normalize tags. The normalized tags may then enable related network elements, components, applications, etc. of different CSPs and/or on-premises data centers to communicate with one another.

In some examples, the tag component 530 may comprise models trained to generate, normalize, and/or sign tags for network elements. For instance, the models may be trained based on one or more of tags associated with a user account of the user, open-sourced data, feedback received from a network administrator of the user account indicating acceptance, rejection, or changes to the generated tag.

In some examples, the tag component 530 may comprise one or more pre-trained models and/or pre-trained weighted models. In some examples, the artificial intelligence models are pre-trained using machine learning techniques. In some examples, the NMS 526 and/or tag component 530 may store machine-trained data models for use during operation of the techniques described herein. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the tag component 530 may update the one or more machine learning models based on feedback received from the NMS 526, outputs from the machine learning models, and/or a network administrator.

The validation system 532 may be configured to validate signatures of tags. For instance, the validation system may correspond to a third-party system that is outside of the multi-cloud mesh and/or a system that is integrated as part of the NMS and/or multi-cloud mesh. In some examples, the validation system 532 may correspond to a certificate authority or other security system that stores public key(s), credential(s), certificate(s), etc. associated with application(s) or other network elements. In some examples, the validation system may store public key(s) associated with the tag(s) and/or application(s). The validation system may be configured to receive a signed tag, a cryptographical signature, and/or an encrypted signature of a tag from the tag component. The validation system may provide, to the tag component and based on the signature, a public key associated with the application. The tag component may validate that the tag is signed by the particular application and verify that the NMS can trust the application.

In some examples, the system may distribute mapping(s) to vPoP(s) once an application and/or tag is validated, and/or a tag is normalized. For instance, the system may store mappings between the tags of incoming tunnel(s) and CIDR(s) to equivalent VPNID, SGTs, etc. In some examples, the system may distribute the mapping to relevant vPoP(s) (e.g., a subset of the vPoP(s) that will receive traffic associated with a particular tag), such that not all vPoP(s) store mappings for every network element, thereby reducing memory and storage utilized by the multi-cloud mesh.

The NMS 526 may further include a data store 516, such as long-term storage, that stores communication libraries 518 for the different communication protocols that the NMS 526 is configured to use or perform. Additionally, the data store 516 may include network topology data 520, such as a model representing the layout of the network components in the MCN and/or multi-cloud mesh 102 and/or data indicating available bandwidth, available CPU, delay between nodes, computing capacity, processor architecture, processor type(s), etc. The data store 516 may store policies 522 that include, but are not limited to, network policy(ies), network controller policy(ies), security data associated with the network, security policies configured for the network, agreement(s) and/or policies between entities, firewall policies, firewall configuration data, network configuration policies, network configuration data, security posture data, organization and/or entity policies, filtering policies, and/or compliance policies configured for the network. The data store 516 may store mapping(s)/data 524 including metadata, security data, identifier(s) (e.g., user, application ID, object ID, entity ID, tunnel ID, CIDR, SGT(s), etc.), correlations between identifiers (e.g., normalized tags), routing protocol data, performance data, traffic data, flow logs, instruction data, location data, telemetry data, or any other data, metadata, and/or information described herein.

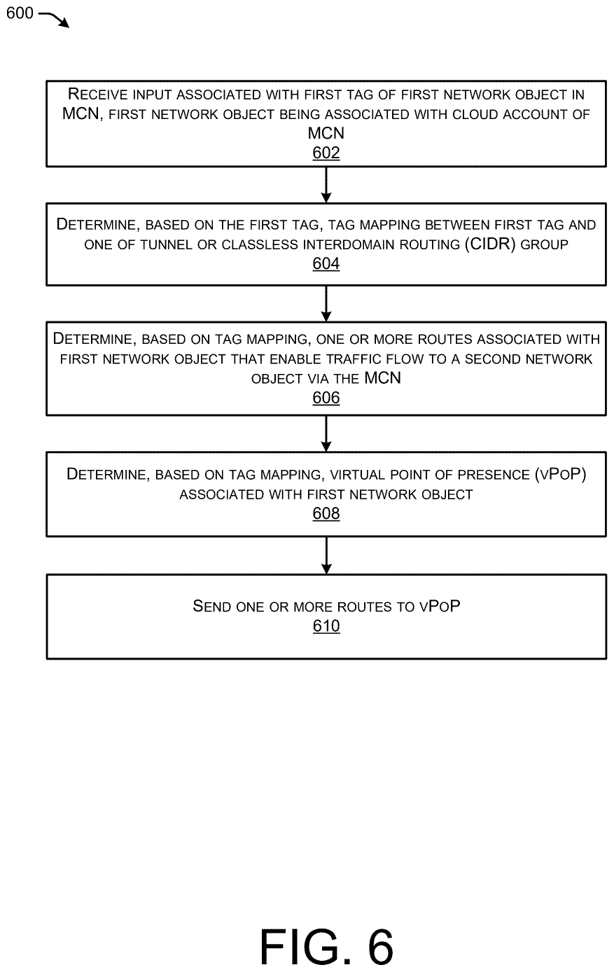

FIG. 6 illustrates a flow diagram of an example system 600 for providing zero-trust routing across cloud service providers, according to the systems and techniques described in FIGS. 1-5. In some instances, one or more of the steps of system 600 may be performed by one or more devices (e.g., the NMS 104, user device(s) 308, etc.) that include one or more processors and one or more non-transitory computer-readable media storing computer-executable instructions that, when executed by the one or more processors, cause the one or more processors to perform operations of system 600.

At 602, the system may include receiving input associated with a first tag of a first network element in the MCN, the first network element being associated with a cloud account of the MCN. For example, the system provides the ability to have a single network management system (NMS) and a method of operation across the CSPs in a multi-cloud network (MCN), so that the customer can run workloads in their cloud of choice for various reasons (e.g., cost, capabilities, mergers/acquisitions, etc.). In some examples, the system may operate gateways in all of the availability zones of all of the CSPs, such that the system may provide MCN management as a service. For instance, the system may correspond to the NMS that includes a dashboard (e.g., such as a Meraki dashboard) and/or is implemented as an application (e.g., such as a SaaS app) that interfaces with a user device of the customer. In some examples, the system may utilize a gateway of a service provider (e.g., such as a Cisco native gateway) instead of a gateway associated with the CSP. The system may be configured to set up encrypted tunnels between all the different gateways in order to route the traffic over the internet and between CSPs.

In some examples, the system includes virtual points of presence (vPoPs). In some examples, the vPoPs comprise cloud native head end (CNHE) vPoPs and may represent an end point that the customer talks to and/or connects to. It is understood that while vPoPs may comprise CNHE vPoPs, other types of containers may be used. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts.

In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. In some examples, the vPoPs may be configured to connect the tenancies (e.g., all of Tenant A together, all of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may comprise a dashboard. In some examples, the dashboard may comprise one or more application(s) and/or API(s) that are provided by a service provider of the multi-cloud mesh (e.g., such as Cisco) to enable a customer to interface with the NMS and generate tags for various network elements. In some examples, the dashboard may enable the user to provide input to create, edit, and/or delete tag(s). In some examples, the dashboard enables the customer to tag network elements across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the network elements that are tagged as “blue” may then be discovered by the NMS and interconnected with each other, whether vPoP is connected via AWS or Azure, and/or whether the vPoP is connected to an on-premises data center (e.g., such as via a catalyst switch or a Meraki switch).

In some examples, the system may comprise a tag component. In some examples, the tag component may be configured to generate and manage tags. For instance, the tag component may be incorporated as part of the NMS, included in the dashboard, and/or included as part of an application on a user device of a customer (e.g., outside of the multi-cloud mesh). For instance, the tag component may receive input from the dashboard. The tag component may be configured to use the input to create a tag associated with a network element. For instance, the customer may provide input that includes values for one or more fields (e.g., tag name, tag value, time stamp, object ID, nonce value, etc.) of a tag. The network elements (e.g., cloud object(s)) may include VPCs, VNETs, subnet(s), instances, network interfaces, or any other object.

At 604, the system may include determining, based on the first tag, a tag mapping between the first tag and one of a tunnel or classless interdomain routing (CIDR) group. For example, the NMS may store and track tags associated with the multi-cloud mesh and/or network elements. For instance, the NMS may store mappings between various tags, CSPs, network elements, identifier(s), etc. in a database of the multi-cloud mesh and/or in memory of the NMS. The NMS may update the mappings based on changes made to tags. As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

Once a tag is normalized and/or validated, the system may be configured to distribute tag mappings (e.g., indicating the normalized tags and/or validated tags) to vPoP(s). or instance, the system may store mappings between the tags of incoming tunnel(s) and/or classless inter domain routing groups (CIDR(s)) to equivalent VPNID, Security Group Tag values (SGTs,) etc. In some examples, the CIDR to tag mappings may comprise CIDR to SGT mappings. For instance, a CIDR to SGT mapping may refer to the process of associating a specific network IP address range (defined using CIDR notation) with a SGT value, which may allow network traffic originating from that IP range (e.g., particular subnet or range of IP addresses) to be identified and treated as belonging to a particular security group of the multi-cloud mesh. A tunnel to tag mapping may refer to one or more tags assigned to traffic traversing a particular tunnel interface and may enable granular policy enforcement based on the tunnel connection, rather than just the source or destination IP addresses.

At 606, the system may include determining, based on the tag mapping, one or more routes associated with the first network element that enable traffic flow to a second network element via the MCN. For example, the system may be configured to establish connections between network elements based on tag mappings, such as tag mappings including normalized and/or verified tags. The NMS may be configured to identify routes between network elements, update routes based on network changes (e.g., a network gets added or removed), etc.

At 608, the system may include determining, based on the tag mapping, a virtual point of presence (vPoP) associated with the first network element. For example, the NMS may be configured to distribute routes to the appropriate network element, CSP, etc. based on tag mappings. Based on the tag mappings, the NMS is aware of which network elements and/or CSPs are communicatively coupled, or interconnected (e.g., which network elements and/or CSPs are allowed to exchange traffic with one another). By way of example, and not limitation, the NMS may determine, based on normalized and/or verified tags, that a network element (e.g., VPC) of a CSP (e.g., AWS) may send traffic to a network element associated with an on-premises data center (e.g., based on the tag of the VPC in AWS corresponding with a VPNID associated with the on-premises data center). Based on this determination, the NMS may be configured to send routes to the appropriate network elements and/or CSPs (e.g., routes to reach the on-premises data center are sent to the AWS VPC). However, the NMS may refrain from sending routes to network elements that are not communicatively coupled (e.g., a VNET associated with Azure, at which a customer has no network elements and/or network elements that are communicatively coupled to the on-premises data center via normalized tags). The NMS may also be configured to send and/or refrain from sending routes to network elements, CSPs, and/or the like based on particular regions. For example, the NMS may be configured to refrain from sending a particular route to a network element of a particular region upon a determination that a customer has no network elements and/or network elements that are communicatively coupled in that region.

At 610, the system may include sending the one or more routes to the vPoP. As described above, tag mappings of normalized and/or validated tags, which may be sent to relevant vPoP(s), may include mappings between the tags of incoming tunnel(s) and/or CIDR(s) to equivalent tags. The NMS may be configured to determine that a tagged network element (e.g., VPC) correlates to a specific network IP address range (defined using CIDR notation), such as via tag normalization. For example, this correlation may allow traffic originating from the VPC of one CSP to be sent to a network element associated with a CIDR block of 10.1.6.0/24. As such, routing information for reaching the network element associated with 10.1.6.0/24 CIDR block may be propagated to the VPC. Additionally, or alternatively, the tagged VPC may not correlate to a network element associated with a CIDR block of 10.1.8.0/24. Accordingly, routing information for reaching the network element associated with the 10.1.8.0/24 CIDR block may not be propagated to the VPC. This way, the VPC may not send traffic to the 10.1.8.0/24 network element in the first place, as opposed to sending traffic to the 10.1.8.0/24 network element, and being unable to reach the 10.1.8.0/24 network element due to a firewall.

Additionally, or alternatively, the system 600 may include receiving, at the first network element, a data packet associated with the one of the tunnel or the CIDR group, and based at least in part on the one or more routes associated with the first network element, routing the data packet to the second network element.

Additionally, or alternatively, the system 600 may include wherein the tag mapping is a first tag mapping, the one of the tunnel or the CIDR group is one of a first tunnel or a first CIDR group, and the one or more routes are one or more first routes, receiving input associated with a second tag of the second network element in the MCN. The system 600 may further include determining, based at least in part on the second tag, a second tag mapping between the second tag and one of a second tunnel or a second CIDR group, determining, based on the second tag mapping, one or more second routes associated with the second network element that enable traffic flow to a third network element via the MCN, and refraining from sending the one or more second routes to the vPoP.

Additionally, or alternatively, the system 600 may include wherein refraining from sending the one or more second routes to the vPoP is further based at least in part on an absence of a tag mapping between the first tag and the one of the second tunnel or the second CIDR group.

Additionally, or alternatively, the system 600 may include receiving, at the first network element, a data packet associated with the one of the tunnel or the CIDR group, and based at least in part on the one or more first routes associated with the first network element, dropping the data packet.

Additionally, or alternatively, the system 600 may include wherein the first tag is associated with a first tag field, the first tag field including at least one of a tag name, tag value, a time stamp, an object identifier, an entity identifier, or a nonce value.

Additionally, or alternatively, the system 600 may include wherein the first network element and second network element comprise one of a virtual private cloud, a virtual network, a network interface, an instance, or a subnet associated with the cloud account.

Additionally, or alternatively, the system 600 may include wherein the tag mapping is a first tag mapping, and the one of the tunnel or the CIDR group is a one of a first tunnel or a first CIDR group, receiving input associated with a second tag of the first network element in the MCN. The system 600 may further include determining, based on the second tag, a second tag mapping between the second tag and one of a second tunnel or second CIDR group, and updating the one or more routes associated with the first network element based at least in part on the second tag mapping.

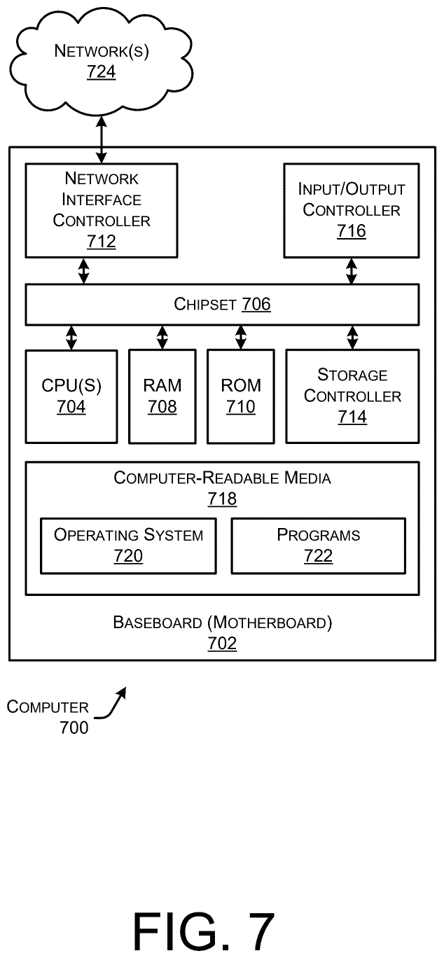

FIG. 7 shows an example computer architecture for a device capable of executing program components for implementing the functionality described above. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a NMS 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs 704”) operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as network(s) 724. The network(s) 724 may correspond to internet 114, the multi-cloud mesh 102, etc. The chipset 706 can include functionality for providing network connectivity through a NIC 712, such as a gigabit Ethernet adapter. The NIC 712 is capable of connecting the computer 700 to other computing devices over the network(s) 724. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the NMS 124, and/or any components included therein, may be supported by one or more devices similar to computer 700. Stated otherwise, some or all of the operations performed by the NMS 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more of a NMS 124, and/or any other device. The computer 700 may include one or more hardware processors (processor(s), such as CPUs 704) configured to execute one or more stored instructions. The processor(s) may comprise one or more cores. Further, the computer 700 may include one or more network interfaces configured to provide communications between the computer 700 and other devices, such as the communications described herein as being performed by the NMS 124, and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 722 may comprise any type of programs or processes to perform the techniques described in this disclosure. For instance, the programs 722 may cause the computer 700 to perform techniques described herein. In this way, the computer 700 may may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of providing zero trust routing in a multi-cloud network (MCN), comprising:
receiving input associated with a first tag of a first network element in the MCN, the first network element being associated with a cloud account of the MCN;
determining, based on the first tag, a tag mapping between the first tag and one of a tunnel or classless interdomain routing (CIDR) group;
determining, based on the tag mapping, one or more routes associated with the first network element that enable traffic flow to a second network element via the MCN;
determining, based on the tag mapping, a virtual point of presence (vPoP) associated with the first network element; and
sending the one or more routes to the vPoP.

2. The method of claim 1, further comprising:
receiving, at the first network element, a data packet associated with the one of the tunnel or the CIDR group; and
based at least in part on the one or more routes associated with the first network element, routing the data packet to the second network element.

3. The method of claim 1, wherein the tag mapping is a first tag mapping, the one of the tunnel or the CIDR group is one of a first tunnel or a first CIDR group, and the one or more routes are one or more first routes, the method further comprising:
receiving input associated with a second tag of the second network element in the MCN;
determining, based at least in part on the second tag, a second tag mapping between the second tag and one of a second tunnel or a second CIDR group;
determining, based on the second tag mapping, one or more second routes associated with the second network element that enable traffic flow to a third network element via the MCN; and
refraining from sending the one or more second routes to the vPoP.

4. The method of claim 3, wherein refraining from sending the one or more second routes to the vPoP is further based at least in part on an absence of a tag mapping between the first tag and the one of the second tunnel or the second CIDR group.

5. The method of claim 3, further comprising:
receiving, at the first network element, a data packet associated with the one of the tunnel or the CIDR group; and
based at least in part on the one or more first routes associated with the first network element, dropping the data packet.

6. The method of claim 1, wherein the first tag is associated with a first tag field, the first tag field including at least one of a tag name, tag value, a time stamp, an object identifier, an entity identifier, or a nonce value.

7. The method of claim 1, wherein the first network element and second network element comprise one of a virtual private cloud, a virtual network, a network interface, an instance, or a subnet associated with the cloud account.

8. The method of claim 1, wherein the tag mapping is a first tag mapping, and the one of the tunnel or the CIDR group is a one of a first tunnel or a first CIDR group, the method further comprising:
receiving input associated with a second tag of the first network element in the MCN;
determining, based on the second tag, a second tag mapping between the second tag and one of a second tunnel or second CIDR group; and
updating the one or more routes associated with the first network element based at least in part on the second tag mapping.

9. A system comprising:
one or more processors; and
one or more computer-readable media storing instructions that, when executed by the one or more processors, cause the one or more processors to perform operations comprising:
receiving input associated with a first tag of a first network element in a multi-cloud network (MCN), the first network element being associated with a cloud account of the MCN;
determining, based on the first tag, a tag mapping between the first tag and one of a tunnel or classless interdomain routing (CIDR) group;
determining, based on the tag mapping, one or more routes associated with the first network element that enable traffic flow to a second network element via the MCN;
determining, based on the tag mapping, a virtual point of presence (vPoP) associated with the first network element; and
sending the one or more routes to the vPoP.

10. The system of claim 9, the operations further comprising:
receiving, at the first network element, a data packet associated with the one of the tunnel or the CIDR group; and
based at least in part on the one or more routes associated with the first network element, routing the data packet to the second network element.

11. The system of claim 9, wherein the tag mapping is a first tag mapping, the one of the tunnel or the CIDR group is one of a first tunnel or a first CIDR group, and the one or more routes are one or more first routes, the operations further comprising:
receiving input associated with a second tag of the second network element in the MCN;
determining, based at least in part on the second tag, a second tag mapping between the second tag and one of a second tunnel or a second CIDR group;
determining, based on the second tag mapping, one or more second routes associated with the second network element that enable traffic flow to a third network element via the MCN; and
refraining from sending the one or more second routes to the vPoP.

12. The system of claim 11, wherein refraining from sending the one or more second routes to the vPoP is further based at least in part on an absence of a tag mapping between the first tag and the one of the second tunnel or the second CIDR group.

13. The system of claim 11, the operations further comprising:
receiving, at the first network element, a data packet associated with the one of the tunnel or the CIDR group; and
based at least in part on the one or more first routes associated with the first network element, dropping the data packet.

14. The system of claim 9, wherein the first tag is associated with a first tag field, the first tag field including at least one of a tag name, tag value, a time stamp, an object identifier, an entity identifier, or a nonce value.

15. The system of claim 9, wherein the first network element and second network element comprise one of a virtual private cloud, a virtual network, a network interface, an instance, or a subnet associated with the cloud account.

16. The system of claim 9, wherein the tag mapping is a first tag mapping, and the one of the tunnel or the CIDR group is a one of a first tunnel or a first CIDR group, the operations further comprising:
receiving input associated with a second tag of the first network element in the MCN;
determining, based on the second tag, a second tag mapping between the second tag and one of a second tunnel or second CIDR group; and
updating the one or more routes associated with the first network element based at least in part on the second tag mapping.

17. One or more non-transitory computer-readable media maintaining instructions that, when executed by one or more processors, program the one or more processors to perform operations comprising:
receiving input associated with a first tag of a first network element in a multi-cloud network (MCN), the first network element being associated with a cloud account of the MCN;
determining, based on the first tag, a tag mapping between the first tag and one of a tunnel or classless interdomain routing (CIDR) group;
determining, based on the tag mapping, one or more routes associated with the first network element that enable traffic flow to a second network element via the MCN;
determining, based on the tag mapping, a virtual point of presence (vPoP) associated with the first network element; and
sending the one or more routes to the vPoP.

18. The one or more non-transitory computer-readable media of claim 17, the operations further comprising:
receiving, at the first network element, a data packet associated with the one of the tunnel or the CIDR group; and
based at least in part on the one or more routes associated with the first network element, routing the data packet to the second network element.

19. The one or more non-transitory computer-readable media of claim 17, wherein the tag mapping is a first tag mapping, the one of the tunnel or the CIDR group is one of a first tunnel or a first CIDR group, and the one or more routes are one or more first routes, the operations further comprising:
receiving input associated with a second tag of the second network element in the MCN;
determining, based at least in part on the second tag, a second tag mapping between the second tag and one of a second tunnel or a second CIDR group;
determining, based on the second tag mapping, one or more second routes associated with the second network element that enable traffic flow to a third network element via the MCN; and
refraining from sending the one or more second routes to the vPoP.

20. The one or more non-transitory computer-readable media of claim 19, the operations further comprising:
receiving, at the first network element, a data packet associated with the one of the tunnel or the CIDR group; and
based at least in part on the one or more first routes associated with the first network element, dropping the data packet.
